(19) United States
(12) Patent Application Publication
(10) Pub. No.: US 2011/0231602 A1
(43) Pub. Date: Sep. 22, 2011

(54) NON-DISRUPTIVE DISK OWNERSHIP CHANGE IN DISTRIBUTED STORAGE SYSTEMS

(76) Inventors: Harold Woods, Colorado Springs, CO (US); Bradley Culter, Magnolia, TX (US)

(21) Appl. No.: 12/727,998

(22) Filed: Mar. 19, 2010

(51) Int. Cl. G06F 12/00

(52) U.S. Cl. 711/112; 711/E12.001

(57) ABSTRACT

Non-disruptive disk ownership change in a distributed storage system is disclosed. The distributed storage system may having a first storage controller for managing a first storage pool, and a second storage controller. An exemplary method may include entering a preparation phase to transfer control of the first storage pool from the first storage controller to the second storage controller. The method may also include suspending writing normal I/O to the first storage pool and holding at the first storage controller any new I/O for the first storage pool. The method may also include rejecting the I/O requests held by the first storage controller after the second storage controller assumes ownership of the first storage pool.

### BACKGROUND

Distributed storage systems, such as storage Area Networks (SANS), are commonplace in network environments. The distributed storage systems includes a plurality of storage cells which may be logically grouped so as to appear as direct attached storage (DAS) units to client computing devices. However, distributed storage systems offer many advantages over DAS units. For example, distributed storage systems eliminate a single point of failure which may occur with DAS units. In addition, distributed storage systems can be readily scaled by adding or removing storage cells to suit the needs of a particular-network environment.

The storage cells in a distributed storage system are managed by storage controllers. The storage controllers are interconnected with one another to allow data to be stored on different physical storage cells while appearing the same as a DAS unit to client computing devices. This configuration also enables high-availability through controller redundancy.

During operation, one or more of the storage controllers may need to pass control of the physical storage cells to another controller. For example, this may occur if one controller in a controller pair fails. The “surviving” controller may enter a write-through mode in an attempt to prevent a higher system-level failure (e.g., losing access to the storage cells of the controller pair, loss of data, and/or compromised data integrity) caused by a subsequent failure of the surviving controller. Conventional solutions require that any data the surviving controller has acknowledged to the host as already being written to the physical storage cells, but that is not yet persisted to disk (referred to as “dirty” data), must first be persisted to disk before switching to another controller pair. The nature of disk drives (e.g., mechanical latency) makes switching to another controller pair a lengthy process. Accordingly, overall performance of the distributed storage system may degrade significantly, and in some instances, may become so severe that applications executing on the host slow to the point of becoming unstable.

### BRIEF DESCRIPTION OF THE DRAWINGS

FIG. 1 is a block diagram of servers which may be implemented in an exemplary distributed storage system.

FIG. 2 is a high-level diagram of the exemplary distributed storage system.

FIG. 3 is an illustrative diagram showing exemplary virtual disks in the distributed storage system.

FIG. 4 is a state diagram illustrating exemplary operations which may be implemented for non-disruptive disk ownership change in a distributed storage system.

### DETAILED DESCRIPTION

Non-disruptive disk ownership change in distributed storage systems is disclosed. Briefly, the systems and methods described herein enable transfer of disk ownership from one storage controller (or controller pair) to another storage controller (or controller pair) to occur quickly and with minimal impact to the storage system. The controllers stay in write-back mode in order to maintain an acceptable level of performance.

When transferring a set of disks to a new storage controller (or controller pair), the “dirty” data is coherent with the new controller pair. In addition, the transfer to another storage controller (or controller pair) can be achieved without global synchronization among all controllers in the cluster. That is, processes for ownership discovery enables other cluster members to automatically locate the new controller pair. Accordingly, the distributed storage system provides storage and redundancy in a manner consistent with applications that demand high availability storage. These and other advantages will be readily apparent to those having ordinary skill in the art after becoming familiar with the teachings herein.

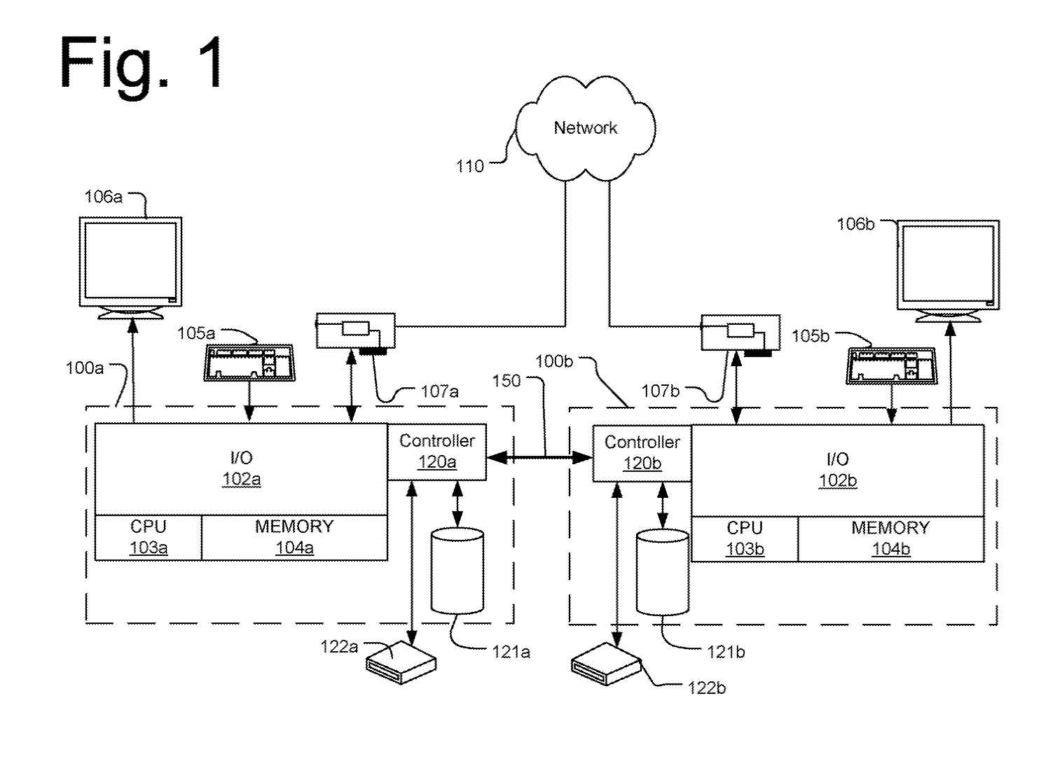

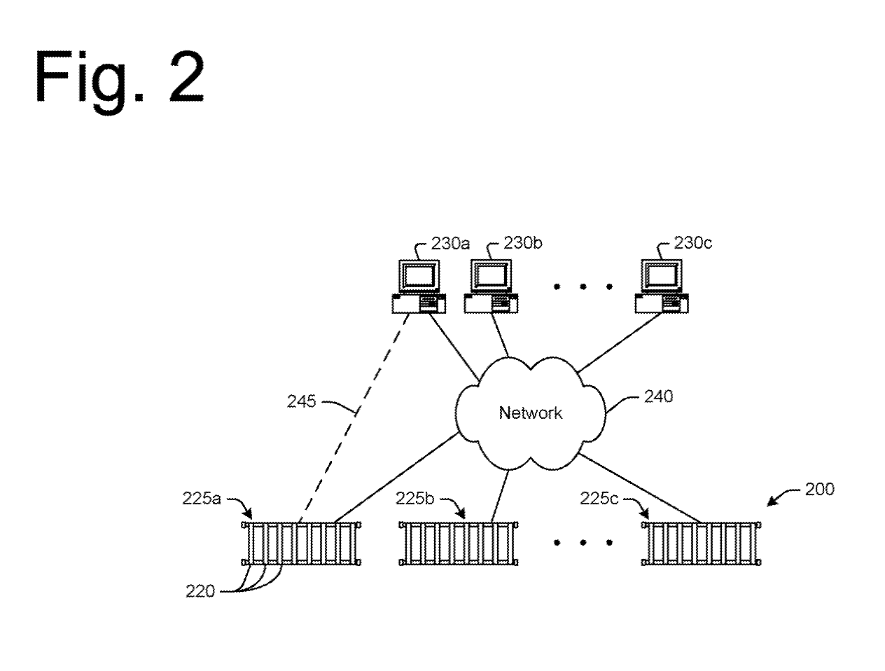

FIG. 1 is a block diagram of servers 100a-b which may be implemented in an exemplary distributed storage system (e.g., system 200 shown in FIG. 2). Although not required, the distributed storage system 200 shown in FIG. 2 is a server-embedded distributed storage system implementing the servers 100a-b. A server-embedded distributed storage system reduces costs associated with deploying and maintaining a network environment by eliminating the need for external storage controllers and related storage area network (SAN) hardware. Instead, the server-embedded distributed storage system uses or reuses hardware that may already be present in the servers, such as, direct attached storage (DAS) devices, storage controllers for the DAS devices, connections (Serial Attached SCSI (SAS), where SCSI is the Small Computer System Interface), Ethernet, etc.), power supplies, cooling infrastructure, etc. However, the server-embedded distributed storage system 200 is described herein only for purposes of illustration and is not intended to be limiting. Other storage systems now known or later developed may also be utilized.

Before describing the server-embedded distributed storage system 200 shown in FIG. 2, it is useful to understand some of the elements of an exemplary server, which may include the storage controller (or controller pairs) discussed in more detail below with regard to non-disruptive disk ownership change. The servers 100a-b shown in FIG. 1 may each include a motherboard having an input/output (I/O) controller 102a-b, at least one processing unit 103a-b (e.g., a microprocessor or microcontroller), and memory 104a-b. The memory 104 may also be referred to as simply memory, and may include without limitation, read only memory (ROM), random access memory (RAM), and/or other dedicated memory (e.g., for firmware).

A basic input/output system (BIOS), containing the basic routines that help to transfer information between elements within the server 100a-b, such as during start-up, may be stored in memory 104a-b. Computer program code (e.g., software modules and/or firmware) containing mechanisms to effectuate the systems and methods described herein may reside in the memory 102a-b or other memory (e.g., a dedicated memory subsystem).

The I/O controller 102a-b is optionally connected to various I/O devices, such as, keyboard 105a-b, display unit 106a-b, and network controller 107a-b for operating in a network environment 110. I/O devices may be connected to the I/O controller 102a-b by means of a system or peripheral bus (not shown). The system bus may be any of several types of bus structures including a memory bus or memory controller, a peripheral bus, and a local bus using any of a variety of bus architectures.

One or more storage controller 120a-b may also be provided in each of the servers 200a-b. In an exemplary embodiment, the storage controller 120a-b is a modified RAID-on-Chip (ROC) storage controller. However, other types of storage controllers now known or later developed may be modified to implement the systems and methods described herein.

The storage controller 120a-b may be connected to one or more storage device, such as internal DAS device 121a-b and external DAS device 122a-b. The DAS devices provide nonvolatile storage of computer-readable instructions, data structures, program modules and other data. It should be appreciated by those skilled in the art that any type of computer-readable media which can store data that is accessible by a computer, such as magnetic cassettes, flash memory cards, digital video disks, random access memories (RAMs), read only memories (ROMs), and the like, may be used in the exemplary operating environment.

In the server-embedded distributed storage system, a plurality of servers may be bound together. In this embodiment, two servers 100a-b are bound together via a suitable interconnect such as via network 110 or other interconnect 150 so that the storage controllers 120a-b can communicate with one another.

In an exemplary embodiment, the servers are C-class blade-type servers and the interconnect is implemented using SAS ports on the controller hardware of each server. Alternatively, rack mount servers may be implemented and the interconnect can again be made using the SAS ports to provide access to a common pool of SAS or SATA drives as well as the inter-controller link interconnect. Other interconnects, such as Ethernet or fibre channel (FC), may also be used to bind the servers so that the storage controllers 120a-b can access volumes on the DAS devices just as they would using conventional external array controllers.

Utilizing existing disk interconnects to enable both array software images to have access to a common pool of disks provides a communications link for necessary operations to enable high availability storage. This configuration also enables other servers to gain access to the storage provided on other servers. The infrastructure is provided at very low-cost and offers the additional benefit of utilizing shared rack space, power and cooling and other system components on the same server which executes applications in the network environment.

The separate hardware infrastructure for the storage controllers provides isolation such that the hardware and program code can be maintained separately from the remainder of the server environment. This configuration allows the maintenance, versioning, security and other policies, which tend to be very rigorous and standardized within corporate IT environments for servers, to be performed without affecting or impacting the storage system. At the same time the storage controllers can be updated and scaled as needed.

It is noted, however, that by utilizing the servers 100a-b internal storage controllers 120a-b in a distributed environment, the storage controllers 120a-b function within the constraints of the server. Accordingly, the firmware for the storage controllers 120a-b enable the negotiations for shared resources, such as memory, interconnects, and processing power. In addition, the firmware enables shared responsibility for managing faults within the server, and notification of faults to the server management software.

FIG. 2 is a high-level diagram showing an exemplary server-embedded distributed storage system 200. The server-embedded distributed storage system 200 may include a plurality of storage cells (illustrated by storage cells 220). In an exemplary embodiment, the storage cells 220 are the DAS devices (either internal, external, or both) in one or more servers, as described above with reference to FIG. 1.

In FIG. 2, the storage cells 220 are shown as they may be logically grouped into one or more virtual disks 225a-c, i.e., as the storage may be “seen” and accessed by one or more client computing device 230a-c (also referred to as “clients”). In an exemplary embodiment, the clients 230a-c may be connected to server-embedded distributed storage system 200 via a communications network 140 and/or direct connection (illustrated by dashed line 245) to the servers. The communications network 240 may include one or more conventional local area network (LAN) and/or wide area network (WAN).

Before continuing, it is noted that the term “distributed storage” is used herein to mean multiple storage “cells.” Each cell, or group of cells resides in a fully functional server (e.g., the server has a processor, memory, network interfaces, and disk storage). Internal storage controllers manage the cells by coordinating actions and providing the functionality of traditional disk-based storage to clients by presenting virtual disks to clients via a unified management interface. The data for the virtual disks is itself distributed amongst the cells of the array. That is, the data stored on a single virtual disk may actually be stored partially on the DAS devices of multiple servers, thereby eliminating the single point of failure.

It is also noted that the terms “client computing device” and “client” as used herein refer to a computing device through which one or more users may access the server-embedded distributed storage system 200. The computing devices may include any of a wide variety of computing systems, such as stand-alone personal desktop or laptop computers (PC), workstations, personal digital assistants (PDAs), or appliances, to name only a few examples. Each of the computing devices may include memory, storage, and a degree of data processing capability at least sufficient to manage a connection to the servers in the server-embedded distributed storage system 200, e.g., via network 240 and/or direct connection 245. A form of client is also the application running on the server which the server-embedded storage system is supporting. This may be implemented as one or more applications or as one or more virtual machines each running one or more application.

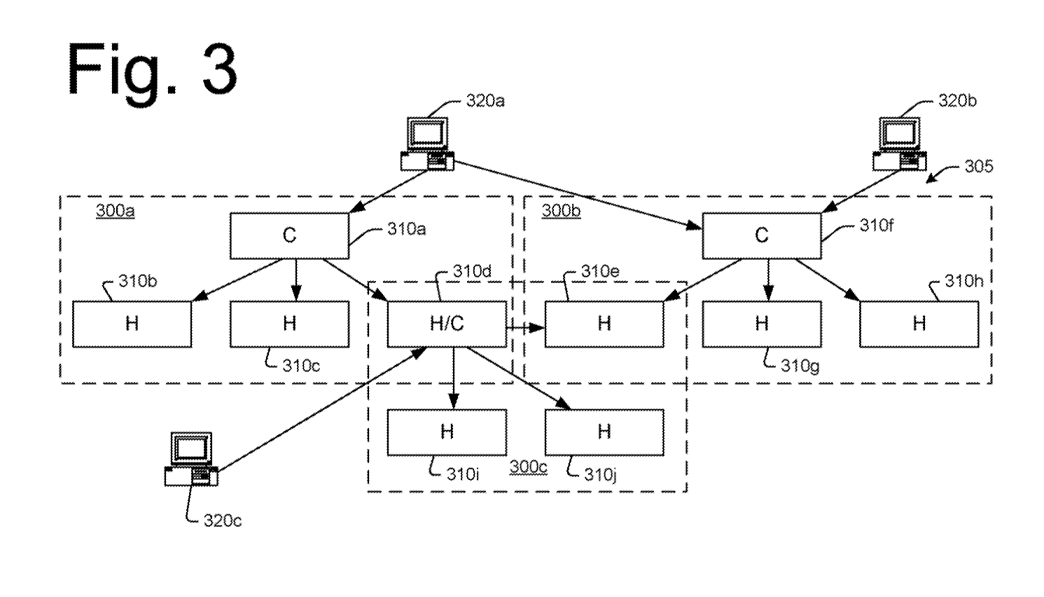

FIG. 3 is a diagram showing exemplary virtual disks 300a-c which may be presented to a client in a server-embedded distributed storage system 305. For example, the virtual disks 300a-c may correspond to the virtual disks 225a-c shown in FIG. 2. Each virtual disk 300a-c may include a logical grouping of storage cells selected from the DAS devices in a plurality of servers (e.g., as shown in FIG. 2). For purposes of illustration, virtual disk 300a is shown including storage cells 310a-d, virtual disk 300b is shown including storage cells 310e-h, and virtual disk 300c is shown including storage cells 310d-e and 310i-j. Although the storage cells 310a-d may reside at different servers within the server-embedded distributed storage system 305, each virtual disk 300a-c appears to the client(s) 320a-c as an individual storage device or “disk”.

When one of the client 320a-c accesses a virtual disk 300a-c for a read/write operation, the storage controller for one of storage cells 310 in the virtual disk 300a-c is assigned as a coordinator (C). The coordinator (C) coordinates transactions between the client 320 and data handlers (H) for the virtual disk. For example, storage cell 310a is assigned as the coordinator (C) for virtual disk 300a, storage cell 310f is assigned as the coordinated (C) for virtual disk 300b, and storage cell 310d is assigned as the coordinator (C) for virtual disk 300c.

It is noted that the coordinator (C) is the storage controller that the client sent the request to, but the storage cells 310 do not need to be dedicated as either coordinators (C) and/or data handlers (H). A single virtual disk may have many coordinators simultaneously, depending on which cells receive the write requests. In other words, coordinators are assigned per write to a virtual disk, rather than per virtual disk. In an exemplary embodiment, a storage cell 310 may be a data handler (H) for a virtual disk while also serving as a coordinator (C) for another virtual disk. In FIG. 3, for example, storage cell 310d is a data handler (H) for virtual disk 300a while also serving as a coordinator (C) for virtual disk 300c. It is also noted that a storage cell 310 may serve as a data handler (H) for more than one virtual disk. In FIG. 3, for example, storage cell 310e is a data handler (H) for both virtual disk 300b and virtual disk 300c.

It is noted that the exemplary embodiments of the server-embedded distributed storage system discussed above are provided for purposes of illustration and are not intended to be limiting. As noted above, the storage system 200 is not required to be a server-embedded distributed storage system. Other storage systems may also be utilized. It is also noted that the storage system can be “mixed,” where the coordinator function in a single system resides in a server (or elsewhere), but has connectivity to the cells and other coordinators. This embodiment enables, for example, a system where one or more of the coordinators needs to be connected to the clients, but not all of the coordinators need to be connected to the client.

As briefly noted above, the distributed storage system may include a number of storage controllers. In an exemplary embodiment, a pool of storage controllers is provided such that in the event of a failure of the storage controller, another controller (or “replacement” controller) may be utilized from the pool to restore high availability or the disks owned by the storage controller may be distributed to other controllers. However, the replacement controller does not need to be a controller from the pool of storage controllers. That is, the replacement controller (or controller pair) may be another operating storage controller (or controller pair). In either case, this concept accommodates independent scaling and failure management.

Pairs of controllers may be bound together to deliver a high availability system. These pairings can be dynamically managed. For example if a server or blade is running a virtual machine and the virtual machine is moved from one server to another, responsibility for managing the disks associated with the data for the application can be moved to the embedded controller in the server where the virtual machine is now hosted without having to copy data.

Exemplary embodiments may also enable load balancing for increasing performance. If a controller is serving data to a server across a network (SAS or Ethernet), the controllers may move responsibility for the disks containing the data to another controller (pair) that is less taxed.

Yet another exemplary embodiment may enable enhanced redundancy in the event of either a server or storage controller failure where the failure results in a loss of normal redundancy. In this case the responsibility for managing the disks may be moved to another controller (pair) or the failed server/embedded controller may be replaced from the pool of controllers and redundancy re-established quickly (seconds/minutes) as opposed to requiring a service call to replace a failed controller in the external controller (SAN) case which may take hours or even days.

In each of these cases, another storage controller (or controller pair) can assume responsibility for I/O for the purpose of load balancing and/or restoration of high availability in the event of a controller failure. In a system where ownership of groups of disks can be moved among storage controllers (or controller pairs), it is desired that the process happen quickly and with minimal if any impact to performance (e.g., as observed by the application utilizing the storage).

Non-disruptive disk ownership change in a distributed storage system, as disclosed herein, moves disk ownership from one storage controller (or controller pair) to another storage controller (or controller pair). The transfer of ownership may be accomplished via an online operation, by synchronizing the write-back cache contents with the receiving pair instead of flushing the write-back cache contents to disk. The current controller (or controller pair) and the new controller (or controller pair) coordinates the transition of ownership through operations which are fully fault tolerant.

In addition, during any preparation for transferring ownership that may be lengthy in duration (e.g., longer than an I/O timeout), normal I/O is able to continue during the preparation. This is accomplished by preparing for the actual transfer of ownership while normal I/O operation continues. When preparations are complete, normal I/O is momentarily held by the current controller pair while moving ownership to the new controller pair. Following the transfer, the held I/O is rejected, along with information notifying the I/O initiator that ownership has changed. The usual process of ownership discovery allows a retry of the failed I/O to complete successfully to the new controller pair. Alternatively, metadata may be returned along with the rejected I/O so that the I/O initiator can more quickly identify the new controller pair for a retry operation.

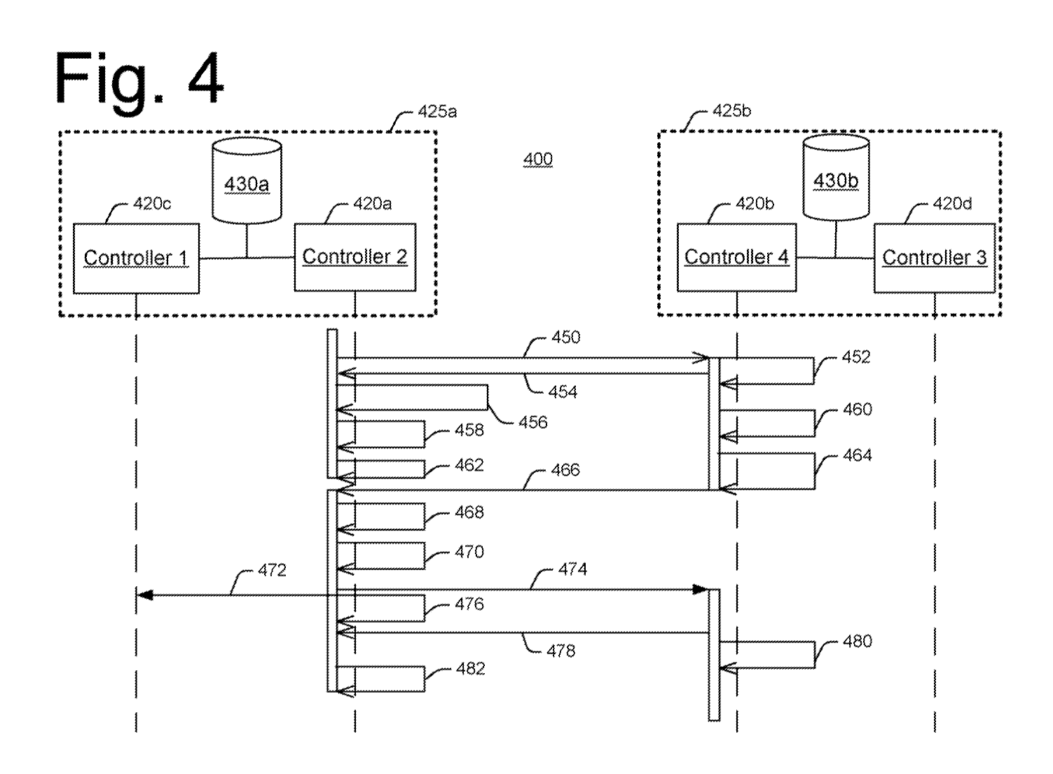

Non-disruptive disk ownership change in a distributed storage system may be better understood with the following discussion and with reference to FIG. 4.

FIG. 4 is a state diagram illustrating exemplary operations 400 which may be implemented for non-disruptive disk ownership change in a distributed storage system. The illustrated operations may be embodied as logic instructions on one or more computer-readable medium. When executed on a processor, the logic instructions cause a general purpose computing device to be programmed as a special-purpose machine that implements the described operations. In an exemplary embodiment, the components and connections depicted in the figures may be used.

Before continuing, it is noted that FIG. 4 illustrates exemplary operations 400 for transferring control of a storage pool 430a from a first controller pair 425a (including storage controller 420a and 420c) to a second controller pair 425b (including storage controller 420b and 420d). However, the operations described herein are equally applicable to transferring control between a first controller pair and a single controller, or between a single controller and a controller pair.

It is also noted that initiating the transfer may be manually (e.g., by a user) or automatically (e.g., by program code) in response to any of a variety of different triggers. For example, a user or program code may monitor operations and trigger transfer in the event of a controller failure and/or for load balancing. Exemplary triggers include, but are not limited to, load balancing, failure of a controller, expansion of the storage system, and moving an application from one server to another server (e.g., the controller is moved to the server where the application is installed for improved performance/efficiency). Furthermore, initiating the transfer reduces the urgency to repair a failed controller, because a new storage controller (or controller pair) takes over I/O operations.

In operation 450, controller 420a sends a request to initiate a transfer ownership of storage pool 430a to controller 420b. In operation 452, controller 420b starts an activity monitor of the storage pool 430a. It is noted that controller 420b and controller 420d continuing servicing I/O and managing storage pool 430b. In operation 454, controller 420b sends an acknowledgement to controller 420a. If controller 420b rejects or does not respond (e.g., if controller 420b has failed), then controller 420a aborts the transfer attempt to controller 420b and may instead initiate a transfer attempt with a different controller.

In operation 456, controller 420a starts an activity monitor of the storage pool 430a. In operation 458, controller 420a prepares to transfer control of the storage pool 430a to controller pair 425b. In operation 460, controller 420b prepares to take over control of the storage pool 430a. In operation 462, controller 420a waits to grant control of the storage pool 430a. In operation 464, controller 420b waits for controller 420a to yield control of the storage pool 430a.

In operation 466, controller 420b grants the transfer request of controller 420a, and controller 420a enters a preparation phase. During the preparation phase, controller 420a suspends writing I/O to the storage pool 430a (operation 468) and holds any new I/O for storage pool 430a that is received at controller 420a (operation 470).

It is noted that the preparation phase described above can be “sufficiently long” (but as short in duration as possible within the command timeouts) to allow the current and new controller pairs to minimize any performance impact, and only suspend normal I/O while dirty data is transferred and ownership is acknowledged. The preparation phase is still well within the timeouts allowed for commands. The preparation phase also does not require participation by any other controllers.

In operation 472, controller 420a and 420c stop mirroring operations of storage pool 430a. Of course, if the reason for transfer is because controller 420c has failed or is unavailable, operation 472 is moot. In operation 474, controller 420a sends controller 420b a request to assume ownership of storage pool 430a. A precondition to sending this message is for controller 420b to update global metadata to identify controller 420b as the owner of storage pool 430a.

In operation 476, controller 420b rejects any new I/O requests. In operation 478, controller 420b accepts ownership of storage pool 430a. In operation 480, controller 420b begins mirroring operations with controller 420d. In operation 482, controller 420a rejects the I/O requests that were held in operation 470. As already mentioned above, ownership discovery allows a retry of the failed I/O to complete successfully to the new controller pair 425b. Alternatively, metadata may be returned along with the rejected I/O so that the I/O initiator can more quickly identify the new controller pair 425b for a retry operation.

Accordingly, access to the data in the storage pool continues to be provided to client(s). That is, the storage pool is fully functional even if one of the storage controllers fails, is unavailable, or control is otherwise transferred to another controller (or controller pair).

The operations shown and described herein are provided to illustrate exemplary embodiments which may be implemented for non-disruptive disk ownership change in a distributed storage system. The operations are not limited to the operations shown or to the ordering of the operations shown. Still other operations and other orderings of operations may be implemented.

It is noted that the exemplary embodiments shown and described are provided for purposes of illustration and are not intended to be limiting. Still other embodiments are also contemplated.

1. A method for non-disruptive disk ownership change in a distributed storage system, the distributed storage system having a first storage controller for managing a first storage pool, and a second storage controller, the method comprising:
entering a preparation phase to transfer control of the first storage pool from the first storage controller to the second storage controller;
suspending writing normal I/O to the first storage pool and holding at the first storage controller any new I/O for the first storage pool; and
rejecting the I/O requests held by the first storage controller after the second storage controller assumes ownership of the first storage pool.

2. The method of claim 1, further comprising triggering the ownership transfer.

3. The method of claim 1, wherein normal I/O operations continue at the first storage controller during preparation for transferring ownership of the first storage pool to the second storage controller.

4. The method of claim 3, wherein the preparation is within a timeout period.

5. The method of claim 3, wherein the preparation is without participation by any other storage controller.

6. The method of claim 3, further comprising holding normal I/O by the first storage controller while ownership of the first storage pool is transferred to the second storage controller.

7. The method of claim 6, further comprising rejecting normal I/O held by the first storage controller after ownership of the first storage pool is transferred to the second storage controller.

8. The method of claim 7, further comprising sending information to an I/O initiator of the normal I/O held by the first storage controller, the information notifying the I/O initiator of ownership transfer of the first storage pool to the second storage controller.

9. The method of claim 8, further comprising client discovery of ownership of the first storage pool by the second storage controller after ownership transfer of the first storage pool to the second storage controller.

10. A distributed storage system comprising:
a first storage controller for managing a first storage pool, and a second storage controller;
an online operation initiated by the first storage controller to provide a disk ownership change, the online operation executable in response to a transfer request to:
suspend writing normal I/O to the first storage pool and holding at the first storage controller any new I/O for the first storage pool; and
reject the I/O requests held by the first storage controller after the second storage controller assumes ownership of the first storage pool.

11. The system of claim 10, wherein the first storage controller is part of a first controller pair.

12. The system of claim 10, wherein the second storage controller is part of a second controller pair.

13. The system of claim 10, wherein the transfer request is initiated manually in response to a trigger.

14. The system of claim 10, wherein the transfer request is initiated automatically in response to a trigger.

15. The system of claim 10, further comprising a trigger to initiate the transfer request, the trigger including at least one of the following: load balancing, failure of a controller, expansion of the storage system, and moving an application from one server to another server.

16. A first storage controller for managing a first storage pool, comprising:
program code including an executable process, the executable process initiated by the first storage controller to provide a non-disruptive disk ownership change, the process being executable to:
send a request to initiate a transfer of ownership of the first storage pool from the first storage controller to a second storage controller;
enter a preparation phase to transfer control of the first storage pool from the first storage controller to the second storage controller;
suspend writing normal I/O to the first storage pool and holding at the first storage controller any new I/O for the first storage pool;
assume ownership of the first storage pool by the second storage controller; and
reject the I/O requests held by the first storage controller.

17. The first storage controller of claim 16, wherein the first storage controller is part of a first controller pair.

18. The first storage controller of claim 16, wherein the second storage controller is part of a second controller pair.

19. The first storage controller of claim 16, wherein the second storage controller manages a second storage pool.

20. The first storage controller of claim 19, wherein the trigger includes at least one of the following: load balancing, failure of a controller, expansion of the storage system, and moving an application from one server to another server.
